(19) United States
(12) Patent Application Publication
(10) Pub. No.: US 2024/0229776 A1
(43) Pub. Date: Jul. 11, 2024

(54) GEOTHERMAL SYSTEMS AND METHODS FOR GENERATING ENERGY

(71) Applicant: Criterion Energy Partners, Inc., Houston, TX (US)

(72) Inventors: Daniel Joseph Rehg, Willis, TX (US); Kenneth Jeffrey Toedter, Spring, TX (US); Jon David Caron, Magnolia, TX (US)

(21) Appl. No.: 18/405,690

(22) Filed: Jan. 5, 2024

Related U.S. Application Data
(60) Provisional application No. 63/437,528, filed on Jan. 6, 2023.

(51) Int. Cl. F03G 4/00

(52) U.S. Cl. CPC F03G 4/001; F03G 4/033

(57) ABSTRACT

A geothermal system for generating electrical power comprises a production well penetrating at least one reservoir, an injection well penetrating the reservoir, and a processing system. The processing system comprises a solids separator configured to receive geothermal fluid from the production well and remove a portion of solids from the geothermal fluid. The processing system further comprises a first turbine configured to reduce a pressure of the geothermal fluid. The processing system further comprises a combination heat exchanger configured to separate the geothermal fluid into a gaseous phase and a liquid phase and to transfer heat from the geothermal fluid to a secondary fluid, wherein the secondary fluid flows within an organic Rankine cycle. The processing system further comprises a vapor recovery unit configured to receive and remove gas from the liquid phase discharged from the combination heat exchanger and direct the liquid phase to the injection well for re-injection.

### CROSS-REFERENCE TO RELATED APPLICATIONS

The present application claims priority to U.S. Provisional Patent Application No. 63/437,528, filed on Jan. 6, 2023, the content of which is hereby incorporated by reference in its entirety.

### BACKGROUND

The present disclosure relates generally to geothermal systems and, more particularly, to geothermal systems and methods for generating energy.

Certain wellbores can access one or more reservoirs within subterranean formations. These reservoirs may be at different locations having different temperatures, fluids, thermal conductivity, heat flow, and pressures. Geothermal systems can utilize these reservoirs to generate energy for further operations. There is a need to selectively access one or more reservoirs within subterranean formations and to configure processing systems to utilize the fluids from the one or more reservoirs for generating and storing energy.

### BRIEF DESCRIPTION OF THE DRAWINGS

The following figures are included to illustrate certain aspects of the present disclosure and should not be viewed as exclusive embodiments. The subject matter disclosed is capable of considerable modifications alterations combinations, and equivalents in form and function, without departing from the scope of this disclosure.

FIG. 1 is a schematic diagram of an exemplary geothermal system, according to one or more aspects of the present disclosure.

FIG. 2A illustrates an example wellbore, according to one or more aspects of the present disclosure.

FIG. 2B illustrates another example wellbore, according to one or more aspects of the present disclosure.

FIG. 2C illustrates a schematic diagram for constructing an example wellbore, according to one or more aspects of the present disclosure.

FIG. 2D illustrates a schematic diagram showing a multi-well pad and zonal development, according to one or more aspects of the present disclosure.

FIG. 2E illustrates a schematic diagram of tubing coatings for an example wellbore, according to one or more aspects of the present disclosure.

FIG. 3A is a schematic diagram of a processing system used for the geothermal system of FIG. 1, according to one or more aspects of the present disclosure.

FIG. 3B illustrates an example combination heat exchanger, according to one or more aspects of the present disclosure.

FIG. 4 is a schematic diagram for lithium extraction, according to one or more aspects of the present disclosure.

FIG. 5 is a schematic diagram of a processing system for a non-geothermal energy application in use for industrial heat, according to one or more aspects of the present disclosure.

FIG. 6 is a schematic diagram of a processing system for applying geothermal energy, according to one or more aspects of the present disclosure.

FIG. 7 is a schematic diagram for recycling plastics, according to one or more aspects of the present disclosure.

FIG. 8 is a schematic diagram for generating hydrogen and ammonia, according to one or more aspects of the present disclosure.

### DETAILED DESCRIPTION

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time consuming but would nevertheless be a routine undertaking for those of ordinary skill in the art having the benefit of the present disclosure.

Throughout this disclosure, a reference numeral followed by an alphabetical character refers to a specific instance of an element and the reference numeral alone refers to the element generically or collectively. Thus, as an example (not shown in the drawings), widget “1a” refers to an instance of a widget class, which may be referred to collectively as widgets “1” and any one of which may be referred to generically as a widget “1”. In the figures and the description, like numerals are intended to represent like elements.

The terms “couple” or “couples,” as used herein, are intended to mean either an indirect or direct connection. Thus, if a first device couples to a second device, that connection may be through a direct connection, or through an indirect electrical connection or a shaft coupling via other devices and connections.

To facilitate a better understanding of the present disclosure, the following examples of certain embodiments are given. In no way should the following examples be read to limit, or define, the scope of the disclosure. Embodiments described below with respect to one implementation are not intended to be limiting.

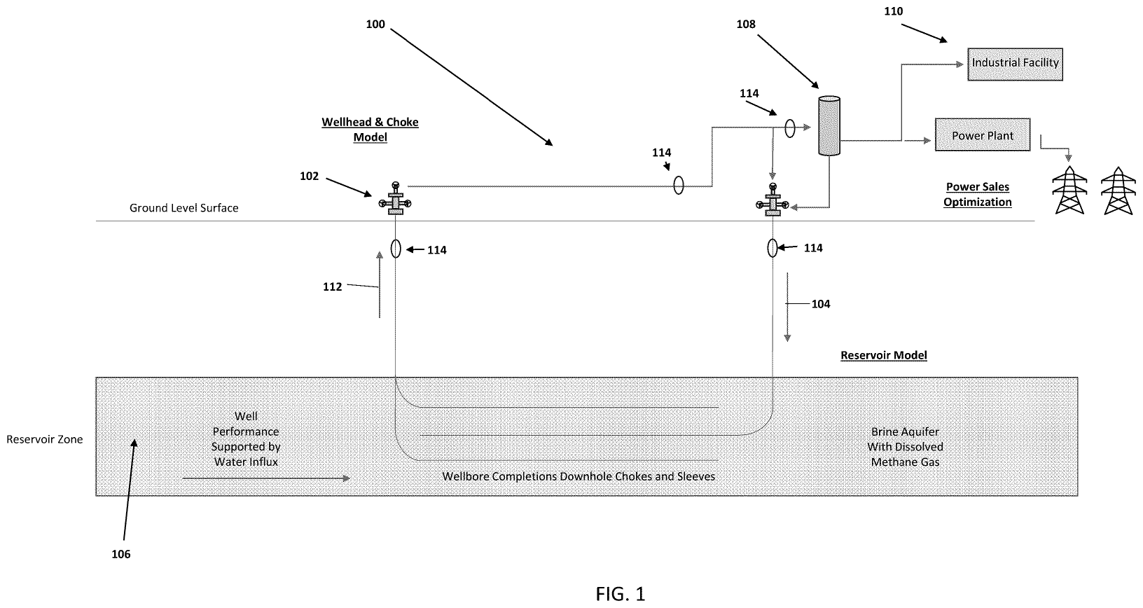

The present disclosure provides for systems and methods for utilizing a geothermal system to generate electricity and to facilitate operation of an external facility with direct heat. The disclosed systems and methods may further utilize by-products such as natural gas and subterranean minerals. The disclosed systems and methods may in certain embodiments, transfer heat from a geothermal fluid located in a reservoir stored within subterranean formations to power generation equipment and to operate external processing facilities with direct heat. FIG. 1 is a schematic diagram of an exemplary geothermal system 100 that may employ the principles of the present disclosure, according to one or more embodiments. As illustrated, the geothermal system 100 may include a production well 102, an injection well 104, at least one reservoir 106, a processing system 108, and an external facility 110. The geothermal system 100 may be a control loop utilized to regulate a parameter to a desired value. For example, the geothermal system 100 may be configured to regulate a temperature and pressure of a produced fluid, such as a geothermal fluid 112, from the production well 102 to be used in generating energy through subsequent operations. In embodiments, the geothermal system 100 may be a closed loop system or an open loop system. With reference to FIG. 1, the geothermal system 100 may be illustrated as a closed loop system, but one of ordinary skill in the art will recognize that the geothermal system 100 may be modified to function as an open loop system. The geothermal system 100 may be operable to cycle a geothermal fluid 112 between the at least one reservoir 106 and a heat exchanger within the processing system 108 to facilitate heat transfer between the geothermal fluid 112 and another fluid circulating about the processing system 108. A person of skill in the art, with the benefit of this disclosure, would understand compositions of the geothermal fluid 112 and any other fluids that would be suitable for certain embodiments of the present disclosure. Such fluids may include, but are not limited to, freshwater, brine, CO₂, CH₄, He, N₂, H₂S, other hydrocarbons, any other combination of liquid or gaseous fluids and solids, and any combination thereof.

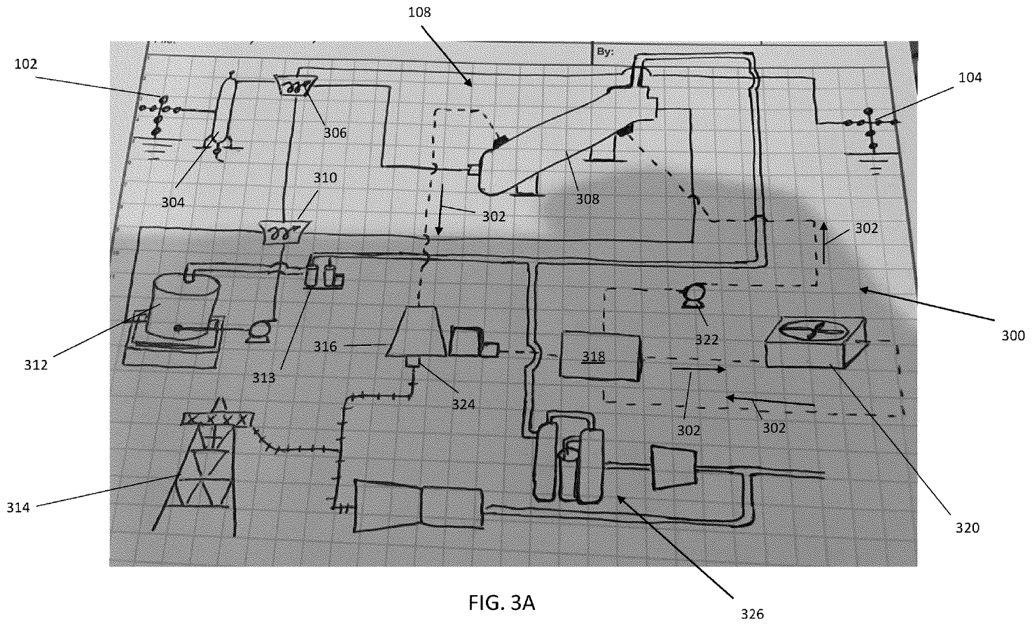

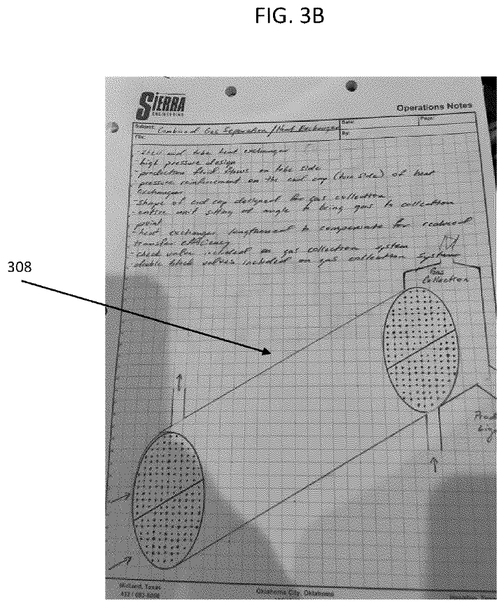

The processing system 108 may be configured to receive heat from the geothermal fluid 112 and to utilize that heat to generate electricity and/or to facilitate downstream processes. With respect to generating electricity, the generated electricity may be transmitted to a power plant or to an electrical grid system for usage. The processing system 108 may comprise any suitable equipment and components associated with surface fluid handling, production, processing and re-injection/disposal. Equipment for power generation (such as turbomachinery), direct heat, and power conversion and distribution processes may also be employed. Such equipment may include or be associated with solids separation units, pressure reduction turbines, gas separation, heat exchangers, gas separation/heat exchange combined systems, gas processing components, gas sales, gas-to-power generation (co-generation), waste heat capture, solar thermal (hybrid thermal), heavy mineral extraction, bioreactors, and step-down power generation. An example of the processing system 108 configuration and its components are described in more detail below in FIG. 3A.

In embodiments, the processing system 108 may be designed to accommodate operation of the external facility 110. For example, the external facility 110 may process chemicals. The processing system 108 may be designed to provide energy in the form of heat transfer to the external facility 110 for operation. In this example, a production well 102 and injection well 104 intersecting at least one reservoir 106 may be drilled and completed in proximity to the external facility 110. The production well 102 and injection well 104 may be fluidly coupled to the processing system 108 which may facilitate heat transfer between the geothermal fluid 112 produced from the at least one reservoir 106 and the external facility 110. With reference to the present disclosure, the reservoir 106 may provide the geothermal fluid 112 at a certain temperature and receive the geothermal fluid 112, after heat transfer, at a lower temperature.

The geothermal system 100 may comprise one or more sensors 114 disposed at various locations along the geothermal system 100. For example, the one or more sensors 114 may be disposed downhole or at a surface location and operable to measure a parameter of the geothermal fluid 112 and/or any other fluid circulating within the geothermal system 100. For example, the one or more sensors 114 may be disposed along the production well 102, along the injection well 104, between either well 102, 104 and processing system 108, within processing system 108, and any combination thereof. Without limitations, the one or more sensors 114 may be configured to measure a temperature, pressure, flow rate, density, and any combination thereof. In embodiments, at least one of each of the one or more sensors 114 may measure one parameter of a fluid. Without limitations, the parameter may be temperature, pressure, density, composition, heat capacity, flow, and any combination thereof. Operation of certain components within geothermal system 100 and processing system 108 may be dependent on measurements received from the one or more sensors 114. The geothermal system 100 is not limited to such a number of one or more sensors 114 or their respective locations, as depicted in the figures.

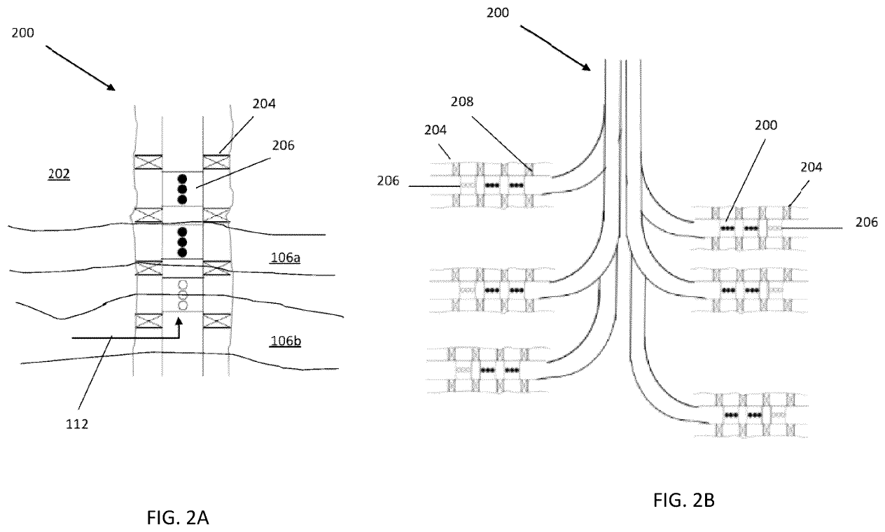

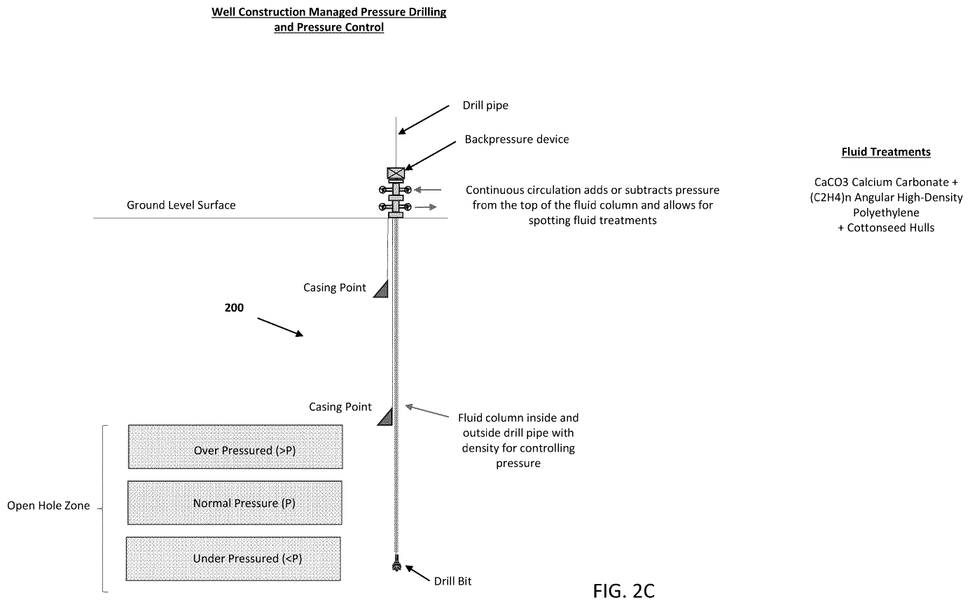

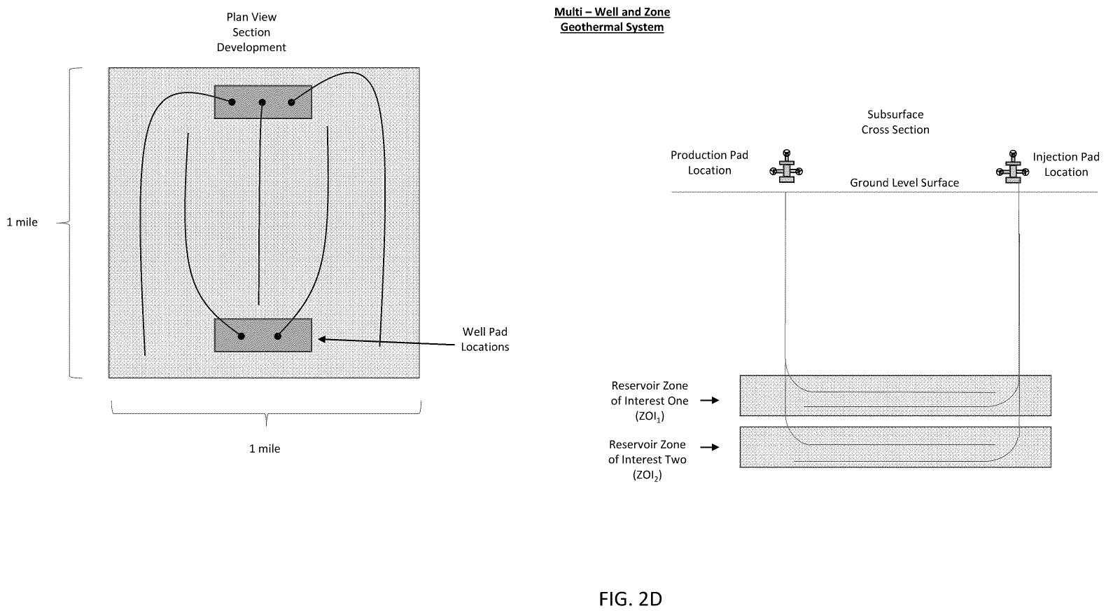

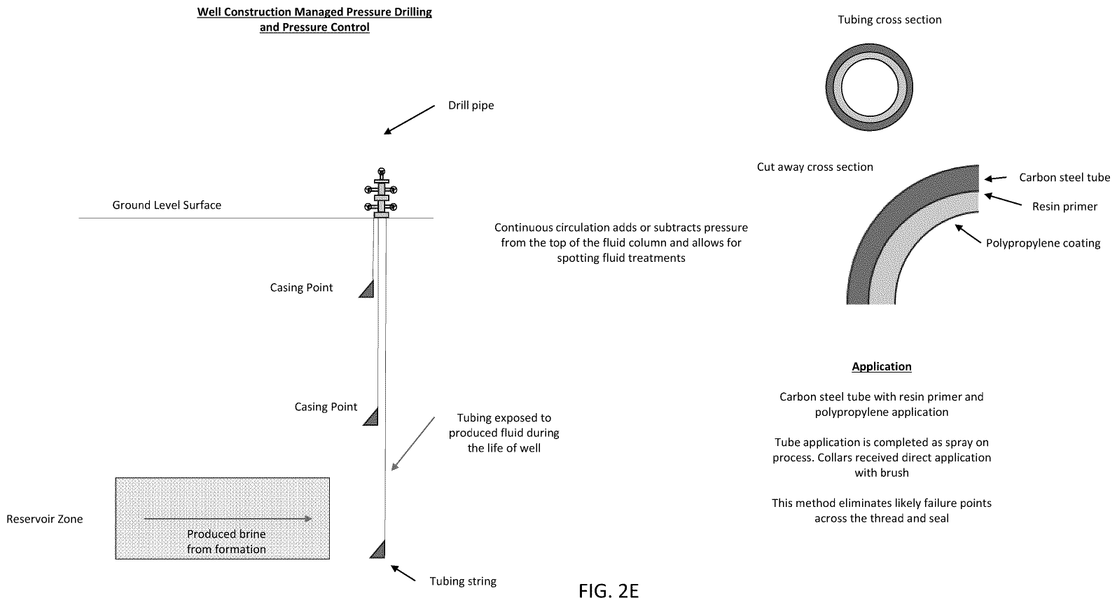

FIG. 2A illustrates an example wellbore 200, according to one or more aspects of the present disclosure. In embodiments, the example wellbore 200 may be representative of the production well 102 (referring to FIG. 1) and/or the injection well 104 (referring to FIG. 1). The wellbore 200 may extend from a ground surface through one or more subterranean formations 202 and penetrate at least a portion of at least one reservoir 106. As illustrated, the wellbore 200 may intersect a plurality of reservoirs 106. The wellbore 200 may be operable to receive the geothermal fluid 112 and either to direct the geothermal fluid 112 to the processing system 108 (referring to FIG. 1) or to inject the geothermal fluid 112 into the reservoir 106, depending on whether the wellbore 200 is operating as the production well 102 or injection well 104. For example, the production well 102 may receive geothermal fluid 112 from the reservoir 106 and direct the received geothermal fluid 112 to the processing system 108. Further, the injection well 104 may receive the geothermal fluid 112 from the processing system 108 and inject the received geothermal fluid 112 into the reservoir 106. In embodiments, the injection well 104 may penetrate at least a separate portion of the reservoir 106 in relation to the production well 102. For example, the production well 102 may be disposed a certain distance away from the injection well 104 penetrating a first portion of the reservoir 106, wherein the injection well 104 may penetrate a second portion of the reservoir 106.

In embodiments, the wellbore 200 may comprise a casing disposed along the circumference within the interior of the wellbore 200. The casing may be any suitable tubular structure configured to maintain the structural integrity of at least a portion of the wellbore 200. For example, a length of the casing may be less than a length of the wellbore 200, wherein the lower portion unprotected by the casing may be an open borehole. In embodiments, wellbore 200 may further comprise a wellhead disposed at a top of the casing and operable to seal the wellbore 200. In embodiments, there may be any other suitable equipment, components, piping, and the like operable to fluidly couple the wellbore 200 to other components within geothermal system 100. In one or more embodiments, there may be a plurality of production wells 102 and/or a plurality of injection wells 104 within the geothermal system 100, wherein one of ordinary skill in the art would recognize that functions and operability of a singular production well 102 or injection well 104 may be applied to the plurality of production wells 102 and the plurality of injection wells 104.

While not specifically illustrated herein, the disclosed systems and methods may also directly or indirectly affect various downhole equipment and tools that may come into contact with treatment fluids during operation (for example, completing wellbore 200, producing from wellbore 200, and/or injecting into wellbore 200). Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems and methods generally described above and depicted in FIG. 2A.

Wellbore 200 may be configured to isolate individual layers within a reservoir 106 to provide the opportunity to recharge pressure or to provide residence time for fluid temperature to equalize with reservoir temperature. For example, wellbore 200 may comprise a plurality of packers 204 and a plurality of sleeves 206. The number of the plurality of packers 204 and sleeves 206 may be equivalent to the number of reservoirs 106 intersecting wellbore 200. The plurality of packers 204 may be operable to isolate portions of the wellbore 200. In embodiments, each packer 204 may be used in conjunction with a work string or any other suitable conveyance. Without limitations, each packer 204 may be secured to the suitable conveyance through any suitable method, including through the usage of fasteners, adhesives, interlocking components, interference fit, and any combination thereof. Each packer 204 may be operable to radially expand a component commonly referred to in the art as a packing element in order to engage with a wall of the wellbore 200 and provide a seal. Each packer 204 may comprise any suitable size, height, shape, and any combinations thereof. Further, each packer 204 may comprise any suitable materials, such as metals, nonmetals, polymers, composites, and any combinations thereof.

As shown, each sleeve 206 may be disposed between a set of packers 204. Each sleeve 206 may be operable to translate in an axial direction, with respect to an axis of the wellbore 200, in order to provide fluid access between the wellbore 200 and at least one reservoir 106. For example, each sleeve 206 may be disposed across a prospective, different reservoir 106, wherein the sleeve 206 may selectively translate to provide fluid flow between that reservoir 106 and the wellbore 200. In this example, the wellbore 200 may have been perforated. Each sleeve 206 may include holes or openings that are covered in a first position (closed) and open in a second position (open) to allow flow from or into the reservoir 106. If the wellbore 200 is representative of a production well 102, actuating one of the sleeves 206 to open may allow fluid flow from the respective reservoir 106 into the production well 102 to be directed up to the surface and to the processing system 108. If the wellbore 200 is representative of an injection well 104, actuating one of the sleeves 206 to open may force fluid flow from the injection well 104 into the respective reservoir 106. Operation of the plurality of sleeves 206 may be based, at least in part, on received measurements from the one or more sensors 114 (referring to FIG. 1). In embodiments, an information handling system may be utilized to transmit, receive, and/or process data related to wellbore 200. For example, the information handling system may receive measurements from the one or more sensors 114 and may execute operations based on the received measurements. The information handling system may be located locally to or remote from the wellbore 200. The information handling system may comprise any suitable hardware, software, firmware, and any combinations thereof to process the data. For example, the information handling system may at least comprise a processor operable to execute instructions and a memory operable to store data.

Although shown as a vertical well, in one or more embodiments, the wellbore 200 may be vertical, horizontal, comprise any angled deviation, and any combination thereof. A person of skill in the art, with the benefit of this disclosure, would understand the wellbore 200 and any other wellbores that would be suitable for certain embodiments of the present disclosure may be drilled and completed using any suitable method and/or technology for drilling and completing a wellbore. Such methods and/or technology may include, but are not limited to, managed pressure drilling, big bore horizontal well construction technology, mud cap drilling systems (i.e., dual gradient drilling), cementing technology for thermal enhancement, heat flow/thermal conductivity measurement logging while drilling, or any other combination of methods and/or technology, and the like. With reference to FIG. 2B, the wellbore 200 may comprise a plurality of lateral bores 208 deviating from a main central bore. In embodiments, each one of the plurality of lateral bores 208 may comprise a plurality of packers 204 and a plurality of sleeves 206 and may operate as described with reference to FIG. 2A. In embodiments, each central bore having a plurality of lateral bores 208 (herein referred to as “multi-laterals”) may comprise one or more junction boxes with varying degrees of sealing capacity, wherein sealing capacity may be measured on a scale from 1 to 5 or greater.

FIG. 2C illustrates a schematic diagram for constructing wellbore 200, and FIG. 2D illustrates a schematic diagram showing a multi-well pad and zonal development. FIGS. 2C-2D may provide elimination of intermediate casing points through management of pore pressure including over and under pressured zones. Wellbore 200 may be constructed through use of managed pressure drilling techniques such as continuous circulation and surface-back pressure combined with drilling fluid spot treatment for managing losses. These processes may allow for larger diameters to be achieved at the production zone and higher mass flow per well. As illustrated, one or more wells may target specific zones or zones of interest in multi-well pads. Both production wells 102 (referring to FIG. 1) and injection wells 104 (referring to FIG. 1) may be located proximate to a centralized processing system 108 (referring to FIG. 1) above one or more zones of interest in a multi-well pad.

FIG. 2E illustrates a schematic diagram for coating one or more tubulars used for wellbore 200 (referring to FIGS. 2A-2B). In embodiments, the one or more tubulars may comprise any suitable material, such as carbon steel. The one or more tubulars may be disposed downhole and line the interior of wellbore 200, which may be used for production wells 102 (referring to FIG. 1) and/or injection wells 104 (referring to FIG. 1). The one or more tubulars may comprise a coating comprising polypropylene or any other suitable coating. In examples, a tubing may be coupled to a drill collar. The coating may be applied to both the tubing and drill collar. In this example, applying the coating to both may eliminate failures at connection points between the two components (such as through threading and seals). In embodiments, the coating may be sprayed onto the tubing and directly applied to the drill collar via brushing.

FIG. 3A is a schematic diagram of the processing system 108 used for the geothermal system 100 of FIG. 1. The processing system 108 may be configured to generate power through an organic Rankine cycle 300 with the received geothermal fluid 112 (referring to FIG. 1) from the production well 102. In embodiments, the geothermal fluid 112 may flow through the processing system 108 and transfer heat to a secondary fluid 302 configured to flow in the organic Rankine cycle 300, wherein the organic Rankine cycle 300 may operate concurrently with the processing system 108. In embodiments, the secondary fluid 302 may include a refrigerant, a coolant, water, nano materials, sorbents and/or other solids, and any combination thereof. In certain embodiments, the nano material may include carbon nanotubes and/or carbon nanostructures. Carbon nanostructures may include 1D, 2D, and 3D structures and include, but are not limited to nanorods, fullerenes, carbon dots, nanodiamonds, graphene, carbon fiber, and the like. The processing system 108 may comprise a solids separator 304, a first turbine 306, a combination heat exchanger 308, a second turbine 310, a storage tank 312, a vapor recovery unit (VRU) 313, and the organic Rankine cycle 300.

The solids separator 304 may receive the geothermal fluid 112 from the production well 102, wherein solids may be collected at a bottom of the solids separator 304 and removed from the geothermal fluid 112. In some embodiments, the solids separator 304 may be multiple solids separators (not shown). One or more solid separators may be oriented in a horizontal or vertical direction, arranged in series or parallel, or oriented or arranged in any suitable combination. For example, in certain embodiments, at least two solid separators may be used when the production well 102 experiences a certain condition (e.g., when the surface operating pressure is at or below 750 psig). The geothermal fluid 112 may be received as a liquid or as a mixture of a liquid and gas. Any suitable separator used for processing fluids may be used as the solids separator 304 in processing system 108. The solids separator 304 may discharge the geothermal fluid 112 with a lower solid content comprising minimal to no solids.

In embodiments, the first turbine 306 may receive the discharged geothermal fluid 112 from the solids separator 304 and reduce the pressure of the geothermal fluid 112. The first turbine 306 may have a plurality of turbine blades, each curved so as to rotate the first turbine 306 due to sufficient fluid flow through the housing of the first turbine 306. The first turbine 306 may be operable to rotate, based on the introduction of a fluid, and produce work. Without limitations, any suitable turbine may be used as the first turbine 306, such as a pressure reduction or power recovery turbine. The first turbine 306 may be coupled to a generator, wherein the work produced by the first turbine 306 may be used by the generator to produce electrical power. In alternate embodiments, the work produced by first turbine 306 may be used by a different component for a separate process. For example, the first turbine 306 may generate work to be used in a pressurization step in a re-injection and/or disposal process for the geothermal fluid 112. In some embodiments, one or more of the turbines may be a capable of providing work for the system (e.g., for re-injection), for turning a shaft for power generation, or both. For example, the released energy from a turbine may be applied to two or more separate shafts: one may be applied to a pump or other rotational device, while the second may apply to power generation through a magneto, dynamo, alternator or other generator design.

The first turbine 306 may discharge the geothermal fluid 112 at a reduced pressure to be directed to either a phase separator (not shown) or to the combination heat exchanger 308. In embodiments, pressure reduction may not be necessary, and the first turbine 306 may be bypassed, wherein the geothermal fluid 112 discharged from the solids separator 304 may be directed to either the phase separator or to the combination heat exchanger 308. In certain embodiments, the fluid may be directed to a phase separator upstream of the combination heat exchanger 308 under one or more conditions. For example, in certain embodiments, a three-phase separator may be used in cases where a geothermal fluid 112 includes free (e.g., liberated) gas and the production well 102. One or more three-phase separators may be oriented in a horizontal or vertical direction, arranged in series or parallel, or oriented or arranged in any suitable combination. In some embodiments, a similar arrangement of three-phase separators may be placed further downstream of the combination heat exchanger 308 in addition to or in place of the upstream three-phase separator. In some embodiments, one or more three-phase separators may be arranged to capture oil or natural gas liquids in the geothermal fluid 112.

The two-phase separator may be operable to separate the liquid phase of the geothermal fluid 112 from the gaseous phase. In these embodiments, the gaseous phase may be directed to an independent processing system separate from the liquid phase of the geothermal fluid 112. The liquid phase may be directed to a heat exchanger (not shown) for direct heat application, to be used in the organic Rankine cycle 300, to direct fluid capture, for solid sorbent regeneration, or a combination thereof. For systems equipped to provide direct heat, an additional fluid system may be introduced to this heat exchanger or to the combination heat exchanger 308 on the shell side to accept heat from the combined fluid stream. That fluid system, such as fresh water combined with other fluid additives to increase the fluid heat capacity, then progresses to an offtaker's nearby facility for use (such as external facility 110).

In some embodiments, in addition to providing heat for ORC power generation, produced fluids may be routed to a heat exchanger specifically designed for solid sorbent regeneration (e.g., sorbents used in direct air capture technologies). The solid sorbent regeneration heat exchanger may be placed downstream of the first heat exchanger discussed above, before the first heat exchanger, or at any other location in the processes and systems of the present disclosure. In some embodiments, produced geothermal fluids 112 may range from 95 to 250° C. In certain embodiments, 20-30% of the geothermal fluid heat may be allocated to binary ORC power generation, with the remaining heat from the process being applied directly to the solid sorbent regeneration process without any additional heat applied. In some embodiments, electricity from a plant may be utilized for providing the roughly 80% thermal and 20% power requirement.

One or more heat exchangers may be operable to transfer heat from the liquid phase of the geothermal fluid 112 to the organic Rankine cycle 300 and/or to the external facility 110 (referring to FIG. 1) through direct heat. Any suitable heat exchanger, or collection of equipment operable to remove heat, may be utilized as the heat exchanger. Without limitations, the heat exchanger may be a shell and tube heat exchanger, plate heat exchanger, plate and shell heat exchanger, plate fin heat exchanger, adiabatic wheel heat exchanger, finned tube heat exchanger, microchannel heat exchanger, and the like. In some embodiments, the heat exchanger may be a liquid-to-liquid heat exchanger. The heat exchanger may employ parallel-flow, counter-flow, cross-flow, and any combination thereof.

As illustrated, in certain embodiments, the combination heat exchanger 308 may be disposed downstream of the first turbine 306 and may receive the discharged geothermal fluid 112. With reference to FIG. 3B, the combination heat exchanger 308 may be a component comprising both a suitable two-phase separator and a suitable heat exchanger, wherein the combination heat exchanger 308 may be configured to perform the operations of both a two-phase separator and a heat exchanger. The combination heat exchanger 308 may be disposed at an angle in relation to a horizontal plane or vertically upwards. A check valve may be disposed about an end cap near an outlet for gas discharge. In embodiments, the combination heat exchanger 308 may be operable to separate the liquid phase of the geothermal fluid 112 from the gaseous phase and to facilitate heat transfer with the geothermal fluid 112. With reference back to FIG. 3A, the combination heat exchanger 308 may be incorporated into the organic Rankine cycle 300, wherein the combination heat exchanger 308 may transfer heat from the geothermal fluid 112 to the secondary fluid 302.

The organic Rankine cycle 300 may be a closed loop system configured to generate power, wherein the generated power may be transmitted to an electrical grid system 314 (or an outgoing transmission line). The organic Rankine cycle 300 may comprise a third turbine 316, a secondary heat exchanger 318, a condenser 320, and a pump 322. As illustrated, the combination heat exchanger 308 may discharge the secondary fluid 302 to the third turbine, wherein the secondary fluid 302 may be discharged from the combination heat exchanger 308 at a higher temperature than previously received by the combination heat exchanger 308 as the combination heat exchanger 308 may have transferred heat to the secondary fluid 302. Similar to the first turbine 306, the third turbine 316 may have a plurality of turbine blades, each curved so as to rotate the third turbine 316 due to sufficient fluid flow through the housing of the third turbine 316. The third turbine 316 may be operable to rotate, based on the introduction of a fluid, and produce work. Without limitations, any suitable turbine may be used as the third turbine 316, such as an organic Rankine cycle turbine. The third turbine 316 may be coupled to a generator 324, wherein the work produced by the third turbine 316 may be used by the generator 324 to produce electrical power. The generator 324 may be operable to convert mechanical energy into electrical power. In one or more embodiments, the amount of work and subsequent electrical power produced may be related to the temperature of the secondary fluid 302. As the temperature of the secondary fluid 302 increases, the amount of work and subsequent electrical power produced may increase. The generator 324 may then transmit the generated electrical power to the electrical grid system 314.

The electrical power generated with the organic Rankine cycle 300 and any power generated from a gas-to-power system may be transformed and synchronized as necessary for transmission through a sub-station either co-located with a power offtaker, or nearby to the external facility 110. The power required to run auxiliary systems in the process, the “parasitic load”, may pull from the same station and may reduce the total power supplied to the offtaker. During times of peak market demand, the design of geothermal system 100 may incorporate variable/dynamic parasitic load shedding, which may allow the operator to cease pumping operations for re-injection and/or disposal. This may reduce the parasitic load. The subsequent increase in net power may then be sent to the public grid (i.e., electrical grid system 314).

Electrical power transmission may be performed through control systems and valves that can bifurcate production and run direct heat in sequence. The control systems may further determine and monitor the parasitic loads. A portion of the electrical power may be reserved for field use and/or for interaction with real-time commodity markets. Apportioning the electrical power may be based on day ahead prices, spot prices, or hedging strategies.

The secondary fluid 302 may be discharged from the third turbine 316 and may be received by a secondary heat exchanger 318. The secondary heat exchanger 318 may a recuperator operable to recover waste heat. The secondary heat exchanger 318 may be a counter-flow energy recovery heat exchanger operable to pre-heat the secondary fluid 302 prior to flowing through the condenser 320. The condenser 320 may receive the secondary fluid 302 from the secondary heat exchanger 318 and may be configured to cool the secondary fluid 302. Any suitable condensing equipment may be used as the condenser 320. Condenser 320 may be any suitable heat exchange device such as a cooler, liquid-to-liquid heat exchanger, air-liquid heat exchanger, heat pump, other thermal dissipation devices, or any combination thereof. In embodiments, the secondary fluid 302 may undergo a phase change back to a liquid phase. The secondary fluid 302 may then flow through the pump 322, wherein the secondary fluid 302 cycles back through the combination heat exchanger 308 to repeat the organic Rankine cycle 300. In embodiments, the pump 322 may be actuated to drive the fluid flow of secondary fluid 302 through the organic Rankine cycle 300. While disposed between combination heat exchanger 308 and secondary heat exchanger 318, pump 322 may be disposed at any suitable location along the organic Rankine cycle 300.

With reference back to the combination heat exchanger 308, the geothermal fluid 112 may be discharged at a lower temperature after transferring heat to the secondary fluid 302. The gaseous and liquid phases of the geothermal fluid 112 may be discharged through separate outlets. The gaseous phase may be directed to independent processing and may be combined with additional gas produced by the liquid phase further downstream. The liquid phase of the geothermal fluid 112 may flow through the second turbine 310 disposed downstream of the combination heat exchanger 308. Similar to the first and third turbines 306, 316, the second turbine 310 may have a plurality of turbine blades, each curved so as to rotate the second turbine 310 due to sufficient fluid flow through the housing of the second turbine 310. The second turbine 310 may be operable to rotate, based on the introduction of a fluid, and produce work. In embodiments, the work produced by second turbine 310 may be used by another component as mechanical work. For example, the second turbine 310 may generate work to be used in a pressurization step in a re-injection and/or disposal process for the geothermal fluid 112

The liquid phase of the geothermal fluid 112 may then be discharged and directed to the storage tank 312 to be held prior to re-injection and/or disposal. As illustrated, the VRU 313 may be coupled to the top of the storage tank 312 to collect free gas and send to compression for sales and/or power generation. The VRU 313 may be a collection of holding tanks and equipment operable to further remove gas or vapors from the liquid phase of the geothermal fluid 112, wherein the freed gas may be combined with the discharged gaseous phase of the geothermal fluid 112 discharged from the combination heat exchanger 308 and flow to components for further processing. The VRU 313 may collect gas as it is released from the stored liquid phase geothermal fluid 112. Any suitable components may be used with the VRU 313, including a gas compressor, a scrubber, an amine unit, a variable frequency drive, a switching device, and any combination thereof. The remaining liquid geothermal fluid 112 may be contained in tanks in proximity to or within the VRU 313 for re-injection into injection well 104, disposal, and/or stored for further processing and/or sale, such as the storage tank 312. For example, further processing for the gas captured by VRU 313 may include dehydration, scrubbing, heating and/or cooling, further phase separation, compression, or any combination thereof.

In some embodiments, gas separated from the geothermal fluid 112 may be directed, via a piping system, to a remote or on-site gas handling facility 326 for further processing. Gas handling facility 326 may comprise any suitable processing equipment, compressors, engines, turbines, and the like. In some embodiments, heat from the geothermal fluid may be utilized in the gas handling facility in one or more processes or pieces of equipment. The heat may be directly available from the geothermal fluid, either as a separate flow stream from the ORC process, or at any point downstream of the ORC process having suitable fluid conditions.

For example, the gas handling facility 326 may include dehydration units (e.g., glycol dehydration units). The dehydration units may heat, either directly or indirectly, a hydrated fluid stream. In some embodiments, the dehydration units may use a heat exchanger, a reboiler, an electric heating apparatus, geothermal heat, or any combination thereof, to heat the hydrated fluid. A person of skill in the art, with the benefit of this disclosure, would understand the electric heating apparatus and any other electric heating apparatus that would be suitable for certain embodiments of the present disclosure may be any suitable process and/or technology for electric heating. Such electric heating apparatus may include, but are not limited to, an induction heating process, a resistive (Joule) heating process, or any other suitable process and/or technology, and the like. In some embodiments, the power of the electric heating apparatus may be supplied from the organic Rankine cycle 300, other system-based power generation methods, or any combination thereof.

In some embodiments, the gas separated from the geothermal fluid 112 may be further processed at a remote or on-site gas handling facility 326. For example, the gas handling facility 326 may further process separated gas using amine treatments (e.g., gas sweetening), membrane treatment, or any other suitable separated gas treatment process and/or technology. In certain embodiments, heat may be provided to the amine treatments by a heat exchanger, a reboiler, an electric powered heating element, or any combination thereof.

In some embodiments, the separated gas may be used for direct power generation. For example, the separated gas may flow through a gas turbine, a gas engine, any other suitable power-generation device, or any combination thereof. In some embodiments, heat may be generated by separated gas power-generation process. This heat and/or power may heat the geothermal fluid 112, either directly or indirectly, by a heat exchanger, a burner, a reboiler, or any combination and/or other suitable heating process and/or technology.

In a continuous or batch process, the liquid flow stream of geothermal fluid 112 may be pulled from the temporary storage tanks of VRU 313 for re-injection and/or disposal. Depending on the pressure of reservoir 106 (referring to FIG. 1), the liquid flow stream may be injected via fit-for-purpose injection wells 104 or disposed of in a shallower zone. Re-injection or disposal may be based on a balance between the pressure of reservoir 106, a proxy for supply, and the parasitic load to re-inject relative to the load for disposal. For example, when reservoir models indicate voidage replacement is required to maintain productivity of the system, re-injection into the producing zone may be required to maintain system performance. Estimated acceptable re-injection surface pressures may be less than about 1500 psi. Otherwise, fluid disposal may be utilized in shallow-zone disposal wells.

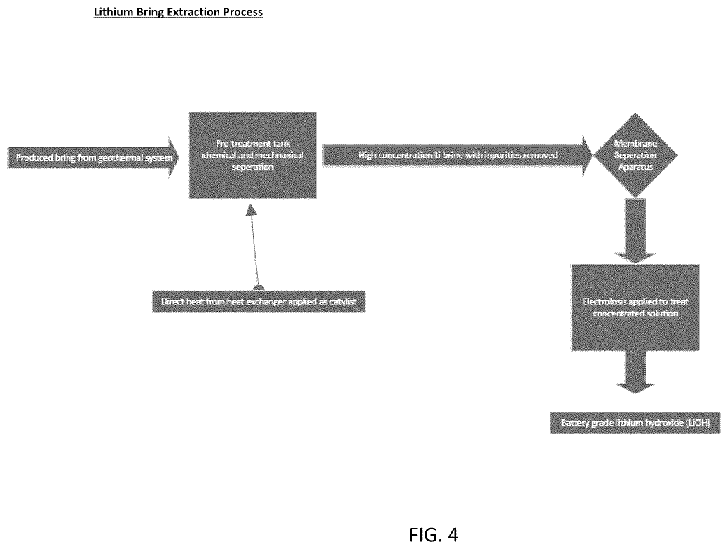

In certain embodiments, the geothermal fluid 112 or separated gas may undergo membrane treatment prior to, during, or subsequent to the other steps and processes discussed herein. In certain embodiments, a membrane treatment may remove one or more components from the geothermal fluid 112. For example, in certain embodiments, a nanofluidic covalent organic framework membrane may be used to treat the geothermal fluid 112. Without wishing to be limited by theory, a nanofluidic covalent framework membranes may in certain embodiments, provide high efficiency lithium extraction from a geothermal fluid 112 (e.g., a brine). In some embodiments, the methods and systems of the present disclosure may be applied to systems like those shown FIG. 4 illustrating a lithium extraction process from the geothermal fluid 112 (or brine). A thermal catalyst may be applied to the geothermal fluid 112 contained within a pre-treatment tank, wherein the geothermal fluid 112 is then forced through at least one membrane. A high concentration lithium solution may be produced. Electrolysis may occur to generate lithium hydroxide. With reference back to FIG. 3A, in some embodiments, the membrane treatment may occur after the organic Rankine cycle 300, or directly prior to re-injection. Chemical and ion treatments may be applied prior to membrane treatment to achieve higher selectivity and mechanical stability. Direct heat from the geothermal process may be applied to achieve accelerated chemical precipitation before or after the membrane separation process.

The geothermal system 100 may incorporate waste heat capture using a high specific heat fluid, such as fresh water, to capture heat from nearby equipment or processes to either increase the temperature of the liquid stream of the geothermal fluid 112 prior to heat exchange with the secondary fluid 302, or to increase the mass flow of the liquid stream in advance of the heat exchange in the combination heat exchanger 308.

The geothermal system 100 may incorporate solar thermal technology to direct solar (thermal) energy, via focused mirrors, to the liquid stream of the geothermal fluid 112 to increase the temperature of the liquid stream. This may occur in advance of the heat exchange in the combination heat exchanger 308 or prior to re-injection in an effort to minimize cooling effects in the reservoir 106, thus reducing the downhole system footprint.

In areas having produced geothermal fluids 112 carrying commercial quantities of heavy minerals, the design of geothermal system 100 may include processes for mining. After gathering freed gas in the temporary storage tanks of VRU 313, the liquid flow stream of geothermal fluid 112 may undergo a chemical treatment to precipitate target minerals, likely proceeding through a series of settling ponds prior to re-injection/disposal.

Geothermal systems 100 may provide heat for bioreactors, wherein they may function similarly to direct heat processes, however, some bioreactors require low enthalpy heat that may be supplied by a downstream flow, allowing the geothermal system 100 to provide primary and secondary, or possibly tertiary, energy services.

Geothermal systems 100 fitted with step-down power generation equipment may utilize mini-turbine or screw expander (or double screw expander) units to capture heat from the liquid flow downstream of the combination heat exchanger 308 (such as second turbine 310) to run an additional low enthalpy organic Rankine cycle process generating further power.

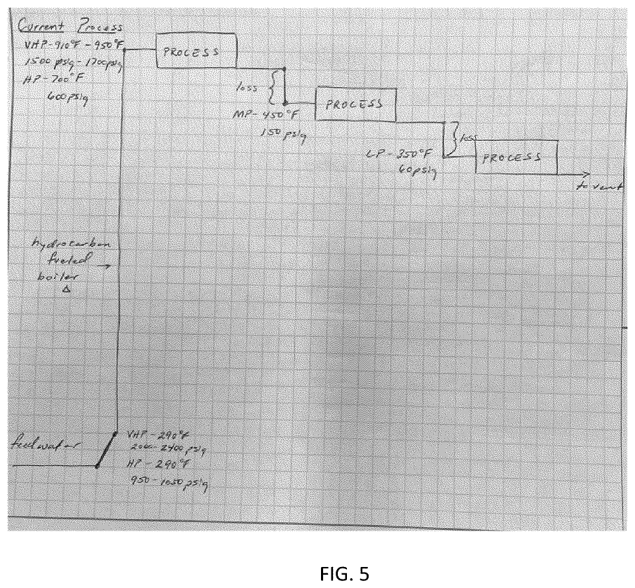

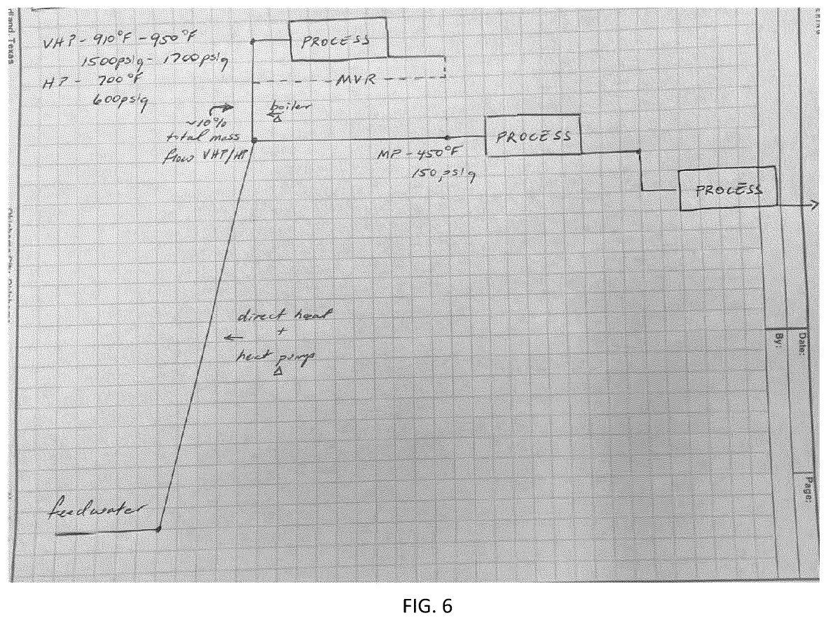

In one example, geothermal heat may be used to pre-heat feedwater intended for steam generation, reducing the heat input required by combustion at the boiler to generate steam, in turn decreasing fuel consumption. For example, as shown in FIG. 5, in some embodiments, geothermal systems may include a hydrocarbon fueled boiler to increase the temperature of geothermal feedwater fluid prior to applying the geothermal energy to industrial processes.

In some embodiments, the methods and systems of the present disclosure may be applied to systems like FIG. 5 to reduce the need for a hydrocarbon fueled boiler. For example, when applied to reduce hydrocarbon fuel combustion and thus the carbon footprint of industrial processes, the methods and systems of the present disclosure may incorporate industrial heat pumps to incrementally increase the temperature of a geothermal fluid or working fluid. In other embodiments, such as the system shown in FIG. 6, an industrial heat pump follows the Carnot Cycle whereby work is input to compress or condense a refrigerant (working) fluid thereby generating (releasing) heat. The heat may then be used to incrementally increase the temperature of the geothermal fluid or a fluid previously heated by the geothermal fluid. The (electrical) power input for such a heat pump may be provided by the geothermal system, or directly input as mechanical work from a pressure reduction turbine, or other source of rotational work, from the system. The combination of geothermal direct heat and an industrial heat pump may generate medium-grade steam. In embodiments, medium-grade steam may refer to steam at about 500 psi and 250° C.

In certain embodiments, higher grade steam conditions may still require the use of a boiler in addition to geothermal heat. If an electric (e.g., induction boiler) is used, geothermal power generation from the systems of the present disclosure may provide the electrical power for the boiler's operation. Further reductions in the boiler fuel consumption may be realized by recirculating out-of-spec downstream steam and integrating a mechanical vapor recompression (MVR) process (as shown in FIG. 6) into the system. In this way, the hydrocarbon fueled boiler, while in continuous operation, only raises a fraction of the system's mass flow of steam from feedwater conditions, based on system losses, and the remaining product is recycled from the out-of-spec post-processed steam; requiring much less energy to reach the desired conditions.

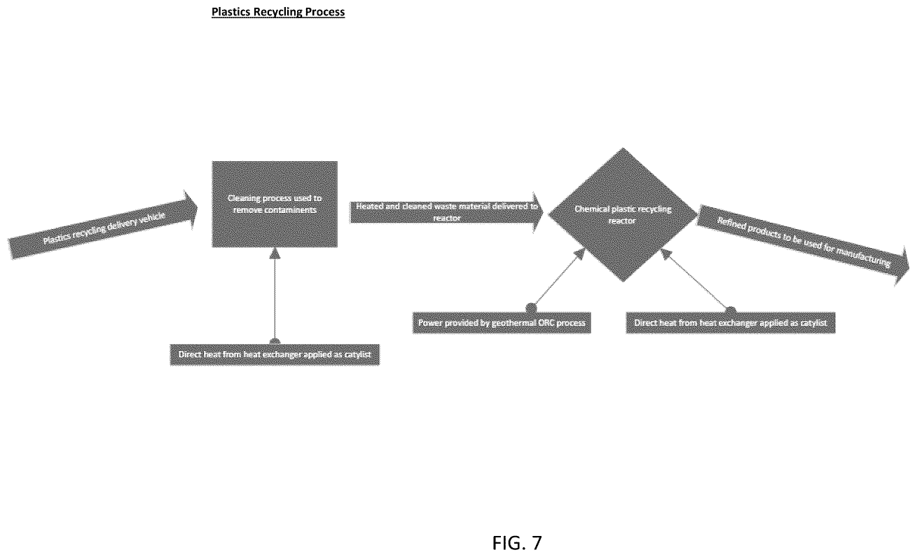

In some embodiments, the methods and systems of the present disclosure may be applied to systems like those shown in FIG. 7 to recycle suitable materials, such as plastics. For example, direct heat generated with the geothermal fluid 112 (referring to FIG. 1) through the processing system 108 (referring to FIG. 3A) may be used to clean any plastics collected through recycling. The generated direct heat may be applied in conjunction with organic Rankine cycle power to chemically recycle one or more plastic components to thereby produce a refined product.

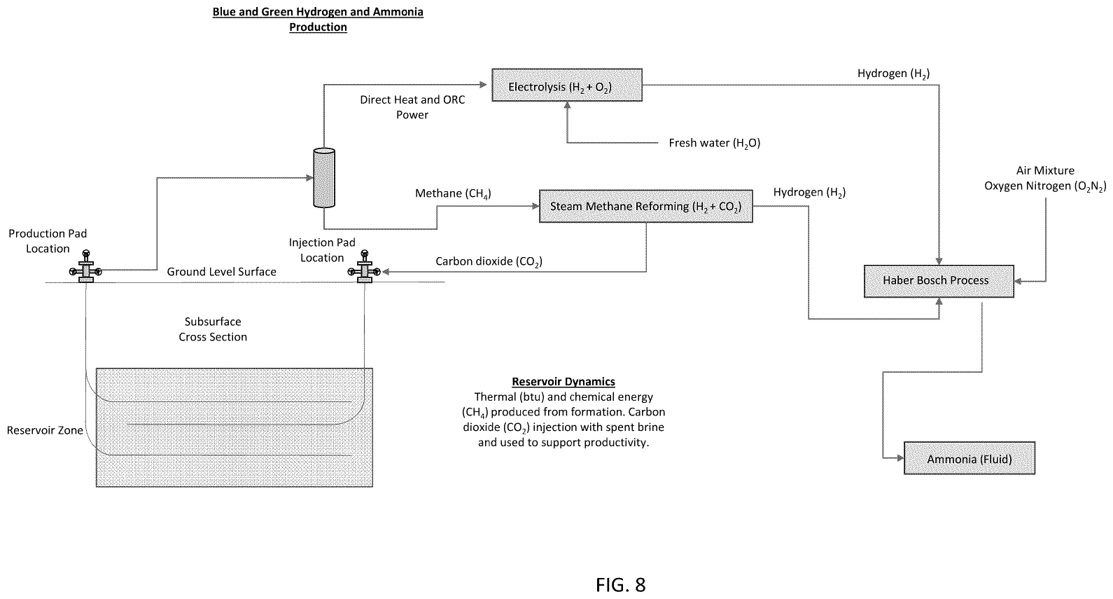

In some embodiments, the methods and systems of the present disclosure may be applied to systems like those shown in FIG. 8 to generate hydrogen and/or ammonia. For example, geothermal fluid 112 (referring to FIG. 1) and methane may be introduced into a system. The system may apply electrolysis and undergo steam reforming. Water, power, and heat may be applied to the methane and geothermal fluid throughout these processes to produce by-products. The by-products may pass through a polymer electrolyte membrane. The by-products may include dihydrogen, nitrogen, iron, and the like. A catalyst and direct heat generated by the geothermal fluid 112 may be applied to produce ammonia.

In certain embodiments, the methods and systems of the present disclosure may include capture and optimization of waste heat. Along with the utilization of direct geothermal heat, waste heat from other processes can be captured by the methods and systems of the present disclosure to increase the temperature and thus overall efficiency of the geothermal fluid for use as direct heat or prior to generating power in the ORC process, or passed through a separate ORC unit for power generation, or potentially any number of methods that may increase thermal efficiency, reduce hydrocarbon fuel consumption, or decrease power demand from external sources.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

What is claimed is:

1. A geothermal system for generating electrical power, comprising:
at least one production well penetrating at least one reservoir and configured to direct a geothermal fluid to a processing system;
at least one injection well penetrating the at least one reservoir and configured to inject the geothermal fluid into the at least one reservoir; and
the processing system configured to generate the electrical power, comprising:
a solids separator configured to:
receive the geothermal fluid from the at least one production well; and
remove at least a portion of solids from the geothermal fluid;
a first turbine configured to:
receive the geothermal fluid from the solids separator; and
reduce a pressure of the geothermal fluid;
a combination heat exchanger configured to:
separate the geothermal fluid into a gaseous phase and a liquid phase; and
transfer heat from the geothermal fluid to a secondary fluid, wherein the secondary fluid flows within an organic Rankine cycle; and
a vapor recovery unit configured to:
receive the liquid phase of the geothermal fluid discharged from the combination heat exchanger;
remove gas from the liquid phase of the geothermal fluid; and
direct the liquid phase of the geothermal fluid to the at least one injection well for re-injection.

2. The geothermal system of claim 1, wherein the organic Rankine cycle comprises a second turbine configured to:
receive the secondary fluid discharged from the combination heat exchanger; and
generate the electrical power by rotating a generator coupled to the second turbine.

3. The geothermal system of claim 2, wherein the organic Rankine cycle further comprises:
a condenser configured to:
reduce a temperature of the secondary fluid; and
direct the secondary fluid to the combination heat exchanger; and
a pump configured to drive a fluid flow of the secondary fluid within the organic Rankine cycle.

4. The geothermal system of claim 1, wherein the processing system is further configured to transmit the generated electrical power to an electrical grid system or to an external facility via a transmission line.

5. The geothermal system of claim 1, further comprising one or more sensors configured to measure a parameter of the geothermal fluid.

6. The geothermal system of claim 1, wherein the at least one production well comprises a sleeve disposed in a wellbore operable to provide fluid communication between the at least one reservoir and the wellbore.

7. The geothermal system of claim 6, wherein the sleeve is disposed between a set of packers and configured to translate in an axial direction with respect to an axis of the wellbore between a first position and a second position to provide the fluid communication between the at least one reservoir and the wellbore.

8. The geothermal system of claim 1, wherein the at least one injection well comprises a sleeve disposed in a wellbore operable to provide fluid communication between the at least one reservoir and the wellbore.

9. The geothermal system of claim 8, wherein the sleeve is disposed between a set of packers and configured to translate in an axial direction with respect to an axis of the wellbore between a first position and a second position to provide the fluid communication between the at least one reservoir and the wellbore.

10. A method for generating electrical power, comprising:
receiving a geothermal fluid from at least one production well penetrating at least one reservoir;
separating the geothermal fluid into a gaseous phase and a liquid phase;
transferring heat from the geothermal fluid to a secondary fluid via a heat exchanger, wherein the secondary fluid flows within an organic Rankine cycle;
generating the electrical power by rotating a generator coupled to a turbine, wherein the turbine receives the secondary fluid discharged from the heat exchanger and is configured to rotate in response to receiving the secondary fluid; and
directing the liquid phase of the geothermal fluid to at least one injection well penetrating the at least one reservoir for re-injection.

11. The method of claim 10, further comprising transmitting the generated electrical power to an electrical grid system or to an external facility via a transmission line.

12. The method of claim 10, further comprising removing at least a portion of solids from the geothermal fluid before directing the geothermal fluid to the heat exchanger.

13. The method of claim 10, further comprising directing the gaseous phase of the geothermal fluid to a gas handling facility.

14. The method of claim 10, further comprising performing a membrane treatment to the liquid phase of the geothermal fluid before re-injection through the at least one injection well.

15. The method of claim 10, further comprising reducing a parasitic load of the generated electrical power by stopping pumping operations during peak demand.

16. A processing system configured to generate electrical power, comprising:
a solids separator configured to:
receive a geothermal fluid from at least one production well; and
remove at least a portion of solids from the geothermal fluid;
a first turbine configured to:
receive the geothermal fluid from the solids separator; and
reduce a pressure of the geothermal fluid;
a combination heat exchanger configured to:
separate the geothermal fluid into a gaseous phase and a liquid phase; and
transfer heat from the geothermal fluid to a secondary fluid, wherein the secondary fluid flows within an organic Rankine cycle; and
a vapor recovery unit configured to:
receive the liquid phase of the geothermal fluid discharged from the combination heat exchanger;
remove gas from the liquid phase of the geothermal fluid; and
direct the liquid phase of the geothermal fluid to at least one injection well for re-injection.

17. The processing system of claim 16, wherein the organic Rankine cycle comprises a second turbine configured to:
receive the secondary fluid discharged from the combination heat exchanger; and
generate the electrical power by rotating a generator coupled to the second turbine.

18. The processing system of claim 17, wherein the organic Rankine cycle further comprises:
a condenser configured to:
reduce a temperature of the secondary fluid; and
direct the secondary fluid to the combination heat exchanger; and
a pump configured to drive a fluid flow of the secondary fluid within the organic Rankine cycle.

19. The processing system of claim 16, wherein the processing system is further configured to transmit the generated electrical power to an electrical grid system or to an external facility via a transmission line.

20. The processing system of claim 16, further comprising one or more sensors configured to measure a parameter of the geothermal fluid, wherein the one or more sensors are disposed within the processing system.
